(19) United States
(12) Patent Application Publication
(10) Pub. No.: US 2022/0151217 A1
(43) Pub. Date: May 19, 2022

(54) DIATOMACEOUS EARTH AND SILICA DUST APPLICATOR

(71) Applicant: S. C. Johnson & Son, Inc., Racine, WI (US)

(72) Inventors: Nathan WOODBURY, Vancouver (CA); Anthony HOOVER, Vancouver (CA); Shannon PYKE, Vancouver (CA)

(21) Appl. No.: 17/526,516

(22) Filed: Nov. 15, 2021

Related U.S. Application Data
(60) Provisional application No. 63/114,458, filed on Nov. 16, 2020.

(51) Int. Cl. A01M 9/00; B05B 7/14

(52) U.S. Cl. CPC A01M 9/00; B05B 7/1486; B05B 7/1463; B05B 7/1413

(57) ABSTRACT

A silica agent applicator includes a reservoir for containing a silica agent. A hollow, deformable bulb is adapted to be squeezed to force air through a first air tube fluidly connecting the bulb and a bottom of the reservoir. A second tube extends from a top of the reservoir to an exit of the applicator, to convey aerosolized silica agent out of the applicator for application onto a surface or an insect.

### CROSS REFERENCE TO RELATED APPLICATIONS

This application claims priority to U.S. Provisional Application Ser. No. 63/114,458, filed on Nov. 16, 2020, and entitled “Diatomaceous Earth and Silica Dust Applicator,” which is incorporated herein by reference in its entirety.

### REFERENCE REGARDING FEDERALLY SPONSORED RESEARCH OR DEVELOPMENT

Not applicable.

### SEQUENTIAL LISTING

Not applicable.

### BACKGROUND OF THE DISCLOSURE

### 1. Field of Disclosure

Some embodiments of the present disclosure relate to improved diatomaceous earth and/or silica dust applicator devices. In particular, some embodiments of the present invention relate to dust applicator devices having one or more of improved physical, user, efficacy, and/or cost characteristics.

### 2. Description of the Background of the Disclosure

Diatomaceous earth and silica dust (collectively referred to as a “silica agent”) are effective at killing many species of terrestrial insect and other arthropods. Diatomaceous earth is comprised mostly of fossilized silicaceous shells of various species of aquatic diatoms, i.e. microalgae. Microscopically, these fossilized shells possess intricate patterns of sharp spines and edges, and the cracked edges of crushed shells are equally sharp and jagged. Most terrestrial insects and other terrestrial arthropods possess an external exoskeleton and gut lining comprised mainly of chitin surrounded by a waxy outer layer. This hydrophobic, waxy outer layer prevents excessive amounts of water from entering and exiting the arthropod's surface. On a microscopic scale, the sharp spines and edges of diatomaceous earth, and the hydrophobic surface of silica dusts easily adhere to the waxy cuticle surrounding terrestrial insects and other arthropods, abrading and absorbing the waxy surface. Perforation and removal of portions of this waxy layer leads to rapid water-loss within the arthropod and eventual death due to desiccation, especially in low humidity environments, or by wax and oil loss. The fact that most terrestrial arthropod species possess a waxy outer layer renders them all susceptible to desiccation when portions of that waxy layer are removed via puncturing or abrasion by diatomaceous earth.

Diatomaceous earth has a low dermal and oral toxicity to humans. Despite diatomaceous earth's ability to kill arthropods, humans that are dermally exposed to low levels of the amorphous form of diatomaceous earth, or that orally consume diatomaceous earth, are not significantly impacted by the exposure. It should be noted however, that chronic inhalation of diatomaceous earth, especially in crystalline form, can lead to pneumocoliosis or silicosis of the lung.

Diatomaceous earth efficacy depends upon contact with the target insect so the diatomaceous earth should be applied where the target pest is found. Diatomaceous earth is efficacious only if it is directly applied to the target arthropod, or if some part of the target arthropod travels over the diatomaceous earth after it has been applied. For this reason, the efficacy of diatomaceous earth is significantly improved if diatomaceous earth can be applied to the known or predicted, current or future location of the target pest. For example, bed bugs typically reside in tight cracks and crevices near sleeping humans. Silverfish reside mainly in humid locations that are sheltered from light but provide access to sources of cellulose or starch. Cockroaches reside under furniture, appliances or counters that are sheltered from light but near food sources. Ants are usually found along pheromonally-conditioned trails connecting nests to food sources. Diatomaceous earth and related silica dusts are effective against each of these target pest species but only if applied precisely to these locations where the particular pest species is most likely to be found.

Diatomaceous earth or silica dust is traditionally applied by scooping or pouring. On a macroscopic scale, diatomaceous earth is a fine, light-weight dust that is very similar to chalk-dust. Diatomaceous earth is somewhat flowable and can be poured from containers, or scooped and then transferred to desired locations. Pesticidal diatomaceous earth is readily available to consumers in flexible bags or inflexible solid containers that may or may not contain a scooping device. In this format, the consumer is expected to either pour the diatomaceous earth directly or scoop the diatomaceous earth from the bag and then transfer it to the current or future location of the target pest.

There are some difficulties associated with pouring diatomaceous earth from a container or scoop. First, the application is labour intensive, particularly along linear target locations, because diatomaceous earth is applied as a series of small piles rather than as a semi-continuous stream. Second, the application is messy because an excessive or inconsistent volume of diatomaceous earth is applied with each pour. Third, linear application of diatomaceous earth along edges, small point applications, and thin surface coatings are not possible because diatomaceous earth is applied as a series of piles. Fourth, diatomaceous earth application to underside surfaces or to many vertical surfaces where target pests reside is not possible because the diatomaceous earth falls vertically from the container or scoop.

Diatomaceous earth or silica dust can be applied using unpowered, directed air flow. The particles of diatomaceous earth are small and light-weight enough to become airborne when exposed to a directed or turbulent stream of air. The particles flow along the stream of air and settle with gravity once the air flow has reduced. In this way, diatomaceous earth can be transferred to desired locations using directed air streams. One common air-flow application method uses a semi-flexible bottle containing a nozzle such as a Yorker bottle or a linear bulb and nozzle assembly (see FIG. 1). If the diatomaceous earth filled bottle or bulb is angled downward, the diatomaceous earth falls toward the nozzle or outlet tube. When the bottle is pressurized by squeezing, diatomaceous earth is ejected with the air-stream that exits the nozzle or outlet tube.

Another common air-flow application method is to use a flexible bellows or a bulb connected to a non-linear exit tube or nozzle located at the base of the bellows or bulb (see FIG. 2A). This arrangement does not require downward angling of the device because diatomaceous earth within the bellows or bulb naturally falls to the base of the bulb and into the exit tube or nozzle. The bellows or bulb is pressurized by squeezing and diatomaceous earth is ejected with the air-stream that exits the nozzle or outlet tube, which then needs to be re-packed with diatomaceous earth via agitation. Alternatively, this style of applicator may be held upside down so that pressure generated with squeezing creates turbulent airflow above the diatomaceous earth, aerosolizing some of diatomaceous earth at the surface (see FIG. 2B).

The current air-flow methods of diatomaceous earth application present some difficulties during use. First, the application is messy, or the volume of diatomaceous earth applied is excessive, because the exit nozzle or tube at the base becomes filled with diatomaceous earth before the bellows or bulb is pressurized. Second, when applying diatomaceous earth to underside surfaces or to vertical surfaces, the diatomaceous earth falls away from the exit nozzle or tube which is angled upwards. As a result, the exit nozzle or tube needs to be repeatedly angled downwards to refill or prime the exit nozzle or tube with diatomaceous earth.

### SUMMARY OF THE INVENTION

According to the present disclosure, improved diatomaceous earth, silica dust or related dust applicators are provided, in accordance with the description and drawings below. In addition to the exemplary aspects and embodiments described above, further aspects and embodiments will become apparent by reference to the following drawings and description.

In one aspect, a silica agent applicator includes a reservoir for containing a silica agent. A hollow, deformable bulb is adapted to be squeezed to force air through a first air tube fluidly connecting the bulb and a bottom of the reservoir. A second tube extends from a top of the reservoir to an exit of the applicator, to convey aerosolized silica agent out of the applicator for application onto a surface or an insect.

In another aspect, a silica agent applicator includes a reservoir for containing diatomaceous earth. A hollow, deformable bulb is adapted to be squeezed to force air through a first air tube fluidly connecting the bulb and a bottom of the reservoir. A second tube extends from a top of the reservoir to an exit of the applicator, to convey aerosolized diatomaceous earth out of the applicator for application onto a surface or an insect.

In some embodiments, the first air tube has an inner diameter within a range of 6 mm to 10 mm. In other embodiments, the first air tube further comprises a constriction with an inner diameter of 3.2 mm. In still other embodiments, the second tube has an inner diameter within a range of 3.5 mm to 6 mm. In yet other embodiments, the applicator dispenses within a range of 0.1 to 1.0 ml of silica agent per squeeze of the bulb. In some embodiments, the applicator dispenses within a range of 0.1 to 1.0 ml of silica agent per squeeze of the bulb, and the squeeze of the bulb is defined as 4 lbs. of hand pressure applied for 1 second. In further embodiments, the reservoir has a removable cap to allow refilling of the silica agent, and the removable cap may be threaded.

In different embodiments, the second tube has a flexible nozzle fluidly connected to dispense from the applicator and is made of a flexible material such that the nozzle can dispense the silica agent into narrow crevices, holes, and wall voids. In still further embodiments, the nozzle has an internal diameter within a range of 3.5 mm to 6.6 mm. In other embodiments, the applicator further comprises supports to allow the applicator to stand vertically during storage.

### BRIEF DESCRIPTION OF THE DRAWINGS

FIG. 1 is a sequence of three orientations of a prior art squeeze bottle dispensing diatomaceous earth when angled upwards, horizontally, and downwards;

FIG. 2A is a sequence of three orientations of a prior art non-linear bellows dispensing diatomaceous earth with the nozzle below the bellows when angled upwards, horizontally, and downwards;

FIG. 2B is a sequence of three orientations of a prior art non-linear bellows dispensing diatomaceous earth with the nozzle above the bellows when angled upwards, horizontally, and downwards;

FIG. 3 is a perspective view of various applications of diatomaceous earth including linear, spot, surface, vertical, and underside applications;

FIG. 4 is a side view of a cross-section of a diatomaceous earth applicator with a rear-faced bulb according to the present disclosure;

FIG. 5 is a side view of a cross-section of a diatomaceous earth applicator with a front-placed bulb according to the present disclosure;

FIG. 6A is a sequence of three orientations of the diatomaceous earth applicator of FIG. 4 dispensing diatomaceous earth when angled upwards, horizontally, and downwards;

FIG. 6B is a sequence of three orientations of the diatomaceous earth applicator of FIG. 5 dispensing diatomaceous earth when angled upwards, horizontally, and downwards;

FIG. 7A is a perspective view of an embodiment of the diatomaceous earth applicator of FIG. 4 that includes supports and is oriented into a vertical position; and

FIG. 7B is a perspective view of an embodiment of the diatomaceous earth applicator of FIG. 5 that includes supports and is oriented into a vertical position.

### DETAILED DESCRIPTION OF THE DRAWINGS

Throughout the following description specific details are set forth in order to provide a more thorough understanding to persons skilled in the art. However, well known elements may not have been shown or described in detail to avoid unnecessarily obscuring the disclosure. Accordingly, the description and tables/drawings are to be regarded in an illustrative, rather than a restrictive, sense. Unless defined otherwise, all technical and scientific terms used herein have the same meaning as commonly understood by one of ordinary skill in the art to which this disclosure belongs. As used herein, singular forms include plural references unless the context clearly dictates otherwise. As used herein, “comprises” or “comprising” are to be interpreted in their open-ended sense, i.e. as specifying that the stated features, elements, steps or components referred to are present, but not excluding the presence or addition of further features, elements, steps or components.

As used herein, all numerical values or numerical ranges provided expressly include integers within such ranges and fractions of the values or the integers within ranges unless the context clearly indicates otherwise. Thus, for example, reference to a range of 90-100%, includes 91%, 92%, 93%, 94%, 95%, 95%, 97%, etc., as well as 91.1%, 91.2%, 91.3%, 91.4%, 91.5%, etc., 92.1%, 92.2%, 92.3%, 92.4%, 92.5%, etc., and so forth. Therefore, as used herein, where a range of values is provided, it is understood that each intervening value between the upper and lower limit of that range and any other stated or intervening value within that stated range is encompassed within embodiments of the disclosure. The upper and lower limits of these smaller ranges may independently define a smaller range of values, and it is to be understood that these smaller ranges are intended to be encompassed within embodiments of the disclosure, subject to any specifically excluded limit in the stated range.

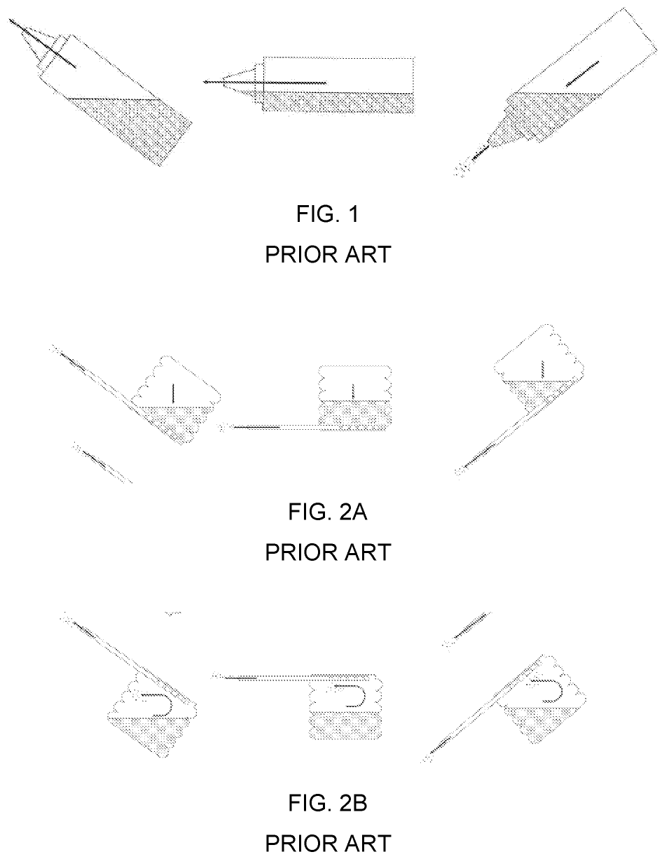

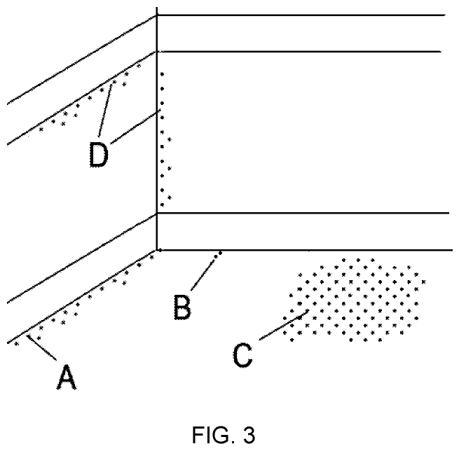

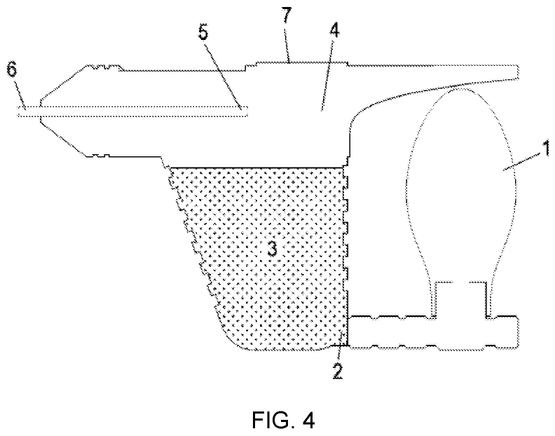

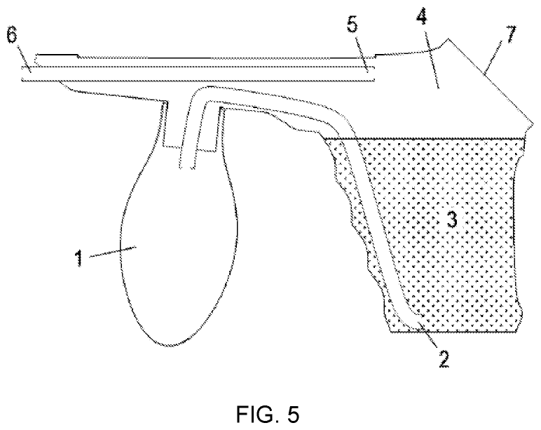

In some embodiments of the present invention, similar to current linear and non-linear prior art bulb and nozzle applicators (see FIGS. 1-2B), embodiments of the present inventive silica agent applicators (see FIGS. 4-7B) are capable of producing a semi-continuous stream application of silica agents linearly, as a small point application, or as a thin surface coating. In addition, the present silica agent applicators allow application of silica agents to both underside and vertical surfaces, including in and around plants. Certain particular embodiments of the present silica agent applicators may desirably improve on currently available linear and non-linear bulb and nozzle applicators in at least the following ways. By way of example, preferred embodiments of the silica agent applicators utilize diatomaceous earth, which for purposes of description only, is described below as one type of silica agent, it being understood that other silica based powders or particles may also be used and considered a silica agent.

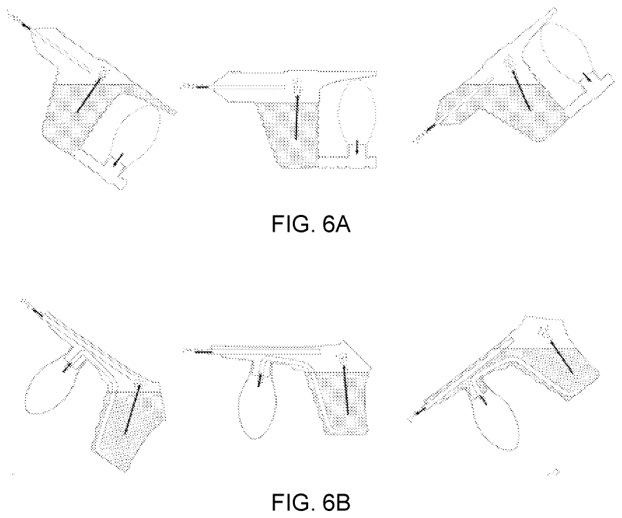

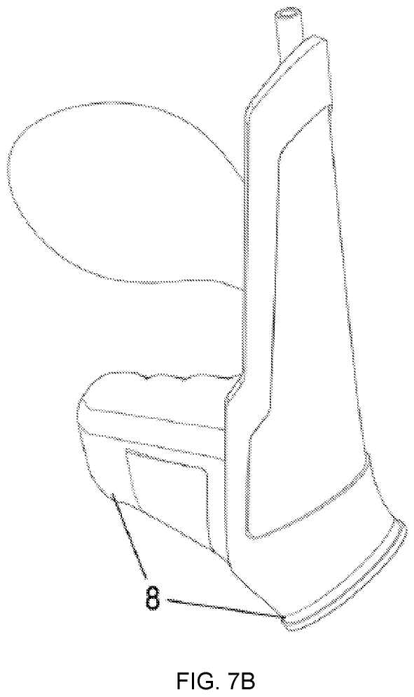

Referring to FIGS. 4 and 5, applicators are shown with a squeeze bulb 1, a pressure tube 2, a supply of diatomaceous earth 3, a reservoir 4, an internal end or inner end of an outlet tube 5, a nozzle 6, and a removable cap 7. In the applicator of FIG. 4, the bulb 1 is more distal from the nozzle 6 than the reservoir 4. In the applicator of FIG. 5, the bulb 1 is more proximate to the nozzle 6 than the reservoir 4. Referring to FIGS. 7A and 7B, in some embodiments, a set of supports 8 are utilized to configure the applicators of FIGS. 4 and 5 to be stored in a vertical fashion as shown.

In one embodiment, the silica agent application volume is desirably consistent and controllable. The applicator applies 0.1-1 ml of diatomaceous earth per squeeze of the bulb or bottle. At a rate of 0.1 ml per squeeze, a diatomaceous earth residue can be applied that is not easily visible on most surfaces yet is efficacious against a variety of arthropods. At rates above 1 ml per squeeze, application of diatomaceous earth becomes less homogenous and messier. These higher volumes are often repellent to many arthropods. At rates below 0.1 ml per squeeze, it is difficult for an observer to see if and where the diatomaceous earth is being applied. Also, the diatomaceous earth can lose efficacy against some arthropods, due to reduced chance of arthropods contacting the lower levels of diatomaceous earth.

The applicator of the present disclosure can apply silica agents to underside surfaces and vertical surfaces continuously, without the need for repeated ‘priming’ of the exit nozzle or tube. Pest arthropods commonly inhabit vertical surfaces or on the undersides of surfaces. Therefore, the ability to apply diatomaceous earth or silica dust to vertical and underside surfaces easily, significantly increases the rate that pest arthropods will encounter the diatomaceous earth or silica dust, thereby increasing its efficacy.

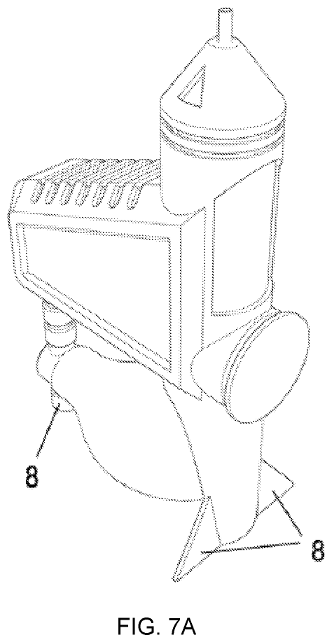

These improvements are possible because the air pressurized within the device or applicator's bulb 1 enters the base of the reservoir 3, at or below the level where diatomaceous earth settles (see FIGS. 4, 5). In this way, the pressurized air-stream is directed under or into the diatomaceous earth and moves upward through the diatomaceous earth. The diatomaceous earth is aerosolized as the diatomaceous earth is driven into the upper portion of the reservoir 4, regardless of the device's orientation (see FIGS. 6A, 6B). In comparison, the horizontal and upward orientations of the prior art linear and non-linear applicators (see FIGS. 1-2B) place the pressurized air-stream over or in front of the diatomaceous earth, allowing the air-stream to exit the nozzle or tube without passing through the diatomaceous earth.

Referring to FIGS. 4 and 5, the internal end of the exit nozzle 6 emerges from the reservoir 4 at a point that is raised vertically above the level of diatomaceous earth 3, ensuring that only airborne, aerosolized diatomaceous earth enters the internal end of the outlet tube 5, and travels through the nozzle 6. Aerosolization of the diatomaceous earth ensures that the volume of diatomaceous earth dispensed, and the air-stream's volume and velocity are closely correlated. This allows an accurate control of the diatomaceous earth volume by adjusting the volume of the bulb 1, by adjusting the inner diameter of the pressure tube 2 or the outlet tube 5, and/or by adjusting the velocity of the air-stream through adjustment of the pressure applied to the bulb 1.

In comparison, the linear and non-linear applicators of the prior art (see FIGS. 1-2B) require diatomaceous earth to be present in the exit nozzle or tube before pressure is applied. Application of pressure forces this non-aerosolized diatomaceous earth out of the exit nozzle or tube before the air in the air-stream can exit. This can lead to application of an inconsistent and excessive volume of diatomaceous earth.

The inventors have discovered (see Study 1 below) that the reservoir 4 can have a range of sizes and volumes, and preferably the volume of the reservoir 4 is within the range from 1000 ml to 6500 ml. In addition, the bulb 1 can be a range of sizes and volumes. The preferred optimal bulb volume is 90 ml and 130 ml respectively, for corresponding diatomaceous earth reservoirs within the range of 3000 ml to 6786 ml (Study 1). The length and inner diameter of the bulb pressure tube 2 can vary, but the preferred optimal inner diameter of the bulb pressure tube is within the range from 6 mm to 10 mm. In addition, the addition of a 3.2 mm diameter constriction element improves aerosolization within the reservoir. In some embodiments, the pressure tube inner diameter is manually adjustable (Study 1).

Further, the inventors have discovered that the length and inner diameter of the outlet tube 5 can be varied, but the preferred range for an optimal inner diameter of the outlet tube is within a range from 3.5 mm to 6.6 mm. In some embodiments, the diameter of the outlet tube, or the constriction (if present) is manually adjustable (see Study 1 below). The length and inner diameter of the nozzle (6) can be varied, but the preferred inner diameter of the nozzle is within a range from 3.5 mm to 6.6 mm. In some embodiments, the nozzle has a short constriction. In some embodiments, the diameter of the outlet tube or constriction (if present) is manually adjustable (Study 1).

In some embodiments, the nozzle 6 is made from a flexible material to allow for the diatomaceous earth to be applied in narrow crevices, in holes, in wall voids, and behind switch plates. In some embodiments, the nozzle 6 is made from or coated with a non-conductive material, to reduce the risk of electrocution when applying diatomaceous earth near, or inside electrical outlets. In some embodiments, the reservoir 4 has a threaded, or otherwise removable cap 7 to allow for the refilling of diatomaceous earth and the selective sealing of the reservoir 4.

The applicators of FIGS. 4 and 5 are configured to apply diatomaceous earth to plants, to leaves and stems, to stored foods or other products, or to any indoor or outdoor surface that can be infested with insects and other arthropods. Below is a disclosure of Study 1 that includes Tables 1-4.

### Study 1—Test of Silica Agent Applicator Prototypes

Purpose—This study was performed to determine the optimal type, size and arrangement of components required to create a hand-powered device capable of applying an optimal quantity of diatomaceous earth in multiple orientations that are not possible using bags, scoops, yorker bottles, or bellows puffers. The goal was to discover a design of a silica agent applicator capable of applying 0.1 to 1 ml of diatomaceous earth per squeeze of the bulb or bottle. At 0.1 ml per squeeze, a diatomaceous earth residue can be applied that is not easily visible on most surfaces yet is efficacious against a variety of arthropods. At rates above 1 ml per squeeze, application of diatomaceous earth becomes less homogenous and messier, and these higher volumes are often repellent to many arthropods. At rates below 0.1 ml per squeeze, it is difficult for an observer to see if and where the diatomaceous earth is being applied, and the diatomaceous earth can lose efficacy against some arthropods due to a reduced chance of arthropods contacting the lower levels of diatomaceous earth.

Materials & Methods—Prototype diatomaceous earth applicators were created by altering four transparent container types: 1) a flexible upright bottle; 2) an inflexible upright bottle; 3) an inflexible upright spherical container; or 4) an inflexible sideways spherical container. Different diatomaceous earth applicator prototypes were created from each container type by altering the position, length, inner diameter, and constriction points of pressure inlet tubes, outlet tubes, and nozzles, and by altering the size, shape, and orientation of the reservoir and/or pressure bulb.

Each prototype applicator was filled with diatomaceous earth to a height of 4 cm (the average diatomaceous earth density was 0.217g/m1) and tightly sealed to ensure air and diatomaceous earth emitted from the applicator's nozzle only, and not from any other components. To quantify each applicator's ability to emit diatomaceous earth, approximately 4 lbs. of hand pressure was applied for 1 second to the bulb or flexible reservoir of each applicator. Any diatomaceous earth emitted from the applicator was collected in a graduated cylinder to quantify the volume of diatomaceous earth emitted. This process was repeated five times for each applicator prototype and the average volume of diatomaceous earth emitted after five trials was calculated.

### Results

Reviewing flexible upright bottles, the optimal diatomaceous earth emission volumes between 0.1 ml to 1 ml were achieved with an outlet tube inner diameter (I.D.) of 6.6 mm and with a nozzle I.D. of 4.1 mm. Optimal diatomaceous earth emission volume also required the outlet tube to be submerged below the resting diatomaceous earth level, rather than above the diatomaceous earth surface. This allowed the pressure generated by squeezing the bottle to be transferred into the diatomaceous earth, to the outlet tube, and then to the nozzle. Adding short, 3 mm I.D. constrictions to the outlet tube did not reduce the diatomaceous earth emission to below the optimum volume. Increasing the nozzle length to 20 cm or adding short 2.4 mm I.D. constrictions to the nozzle also did not reduce diatomaceous earth emission below the optimum volume. If the I.D. of the outlet tube was reduced to 3.6 mm, or the I.D. of the nozzle was reduced to 3 mm, the diatomaceous earth emission volume was reduced below the optimal volume. If the I.D. of the outlet tube was increased to 11 mm, the diatomaceous earth emission volume was excessive and inconsistent. However, this was not observed when multiple 6.6 mm I.D. outlet tubes were added (see Table 1 below).

Reviewing inflexible upright bottles, upright spherical containers, and sideways spherical containers, as a result of their container inflexibility, each of these container types required the addition of a flexible bulb and pressure outlet tube to generate pressure. Optimal diatomaceous earth emission volumes in these inflexible bottles required the bulb's pressure tube to be submerged below the resting diatomaceous earth level and also required the entrance of the outlet tube to sit above the resting diatomaceous earth level. This arrangement of parts allowed the pressure generated by the bulb to be transferred to the pressure tube, then directly into the diatomaceous earth where it was aerosolized into the reservoir, and then onto the outlet tube and nozzle. When the pressure tube was not submerged below the diatomaceous earth level, the pressure tube did not adequately aerosolize diatomaceous earth within the container. If the outlet tube was too high above the diatomaceous earth level (e.g., a distance of 11 cm in at least one container tested), an insufficient volume of aerosolized diatomaceous earth entered the outlet tube and exited the nozzle. When the outlet tube was submerged below the diatomaceous earth level, excessive and inconsistent volumes of diatomaceous earth entered the outlet tube and exited the nozzle (see Tables 2-4).

Even when the pressure tube and outlet tube distances from the diatomaceous earth level were ideal, increasing the volume of the reservoir (for inflexible containers) from 3000 ml to 6786 ml reduced the volume of emitted diatomaceous earth to below optimal levels. This was due to the volume of aerosolized diatomaceous earth per container volume being reduced. In larger containers, such as 6786 ml containers, the volume of aerosolized diatomaceous earth was increased to optimal levels when the pressure bulb volume was increased from 90 ml to 130 ml (see Tables 2-4).

The optimal diatomaceous earth emission volume was achieved in cylindrical and conical inflexible containers when the pressure tube and the outlet tube position were optimized. However, tilting these container shapes positive or negative 90 degrees allowed diatomaceous earth to settle into the corners or sides of the containers, exposing the pressure tubes, or submerging the outlet tubes. This exposure or submerging created diatomaceous earth emission volumes that were not optimal. In comparison, in spherical containers, the diatomaceous earth tended to fall to the lowest point in the sphere when tilted at a positive or a negative 45 degrees. If the pressure tube exited below the diatomaceous earth level, near this low point, at zero degrees tilt, the pressure tube remained below the diatomaceous earth level even when the device was oriented positive or negative 45 degrees. If the entrance to the outlet tube was positioned close to the top-center or top-rear of the sphere, above the diatomaceous earth level, the entrance remained exposed even when the device was oriented positive or negative 45 degrees. This submersion of the pressure tube and exposure of the outlet tube at various angles allowed for the emission of optimum diatomaceous earth volumes at various angles (see Tables 2-4).

Ideal diatomaceous earth emission volumes and pressure control was achieved when the pressure tube I.D. was in a range of from 6 mm to 10 mm, or when the number of pressure tubes was increased. Adding a short 3.2 mm I.D. constriction increased the pressure entering the diatomaceous earth and increased the volume of aerosolized diatomaceous earth to optimal levels within the reservoir. Ideal diatomaceous earth emission volumes were also achieved when the outlet tube I.D. was within a range of from 3.5 mm to 6.6 mm, and when the nozzle I.D. was within a range of from 3.5 mm to 6.6 mm. Decreasing the nozzle I.D. to 2.5 mm decreased the volume of emitted diatomaceous earth to below an optimal volume (see Tables 2-4).

TABLE 1

| | | Volume of | Pressure | | | Pressure tube | Pressure tube | | |
|---|---|---|---|---|---|---|---|---|---|
| | Pressure | pressure | tube | Pressure | Pressure | height above/ | constriction | Reservoir | |
| Design | Generating | generating | inner | tube | tube | below 4 cm | inner | volume | Reservoir |
| Name | Component | component | diameter | length | orientation | DE level (cm) | diameter (mm) | (ml) | height |
| SB 1 | flexible | 3000 ml | n/a | n/a | n/a | n/a | n/a | 3000 ml | 15 cm |
| | bottle | | | | | | | | |
| SB 2 | flexible | 3000 ml | n/a | n/a | n/a | n/a | n/a | 3000 ml | 15 cm |
| | bottle | | | | | | | | |
| SB 3 | flexible | 3000 ml | n/a | n/a | n/a | n/a | n/a | 3000 ml | 15 cm |
| | bottle | | | | | | | | |
| SB 4 | flexible | 3000 ml | n/a | n/a | n/a | n/a | n/a | 3000 ml | 15 cm |
| | bottle | | | | | | | | |
| SB 5 | flexible | 3000 ml | n/a | n/a | n/a | n/a | n/a | 3000 ml | 15 cm |
| | bottle | | | | | | | | |
| SB 6 | flexible | 3000 ml | n/a | n/a | n/a | n/a | n/a | 3000 ml | 15 cm |
| | bottle | | | | | | | | |
| SB 7 | flexible | 3000 ml | n/a | n/a | n/a | n/a | n/a | 3000 ml | 15 cm |
| | bottle | | | | | | | | |
| SB 8 | flexible | 3000 ml | n/a | n/a | n/a | n/a | n/a | 3000 ml | 15 cm |
| | bottle | | | | | | | | |
| SB 9a | flexible | 3000 ml | n/a | n/a | n/a | n/a | n/a | 3000 ml | 15 cm |
| | bottle | | | | | | | | |
| SB 9b | flexible | 3000 ml | n/a | n/a | n/a | n/a | n/a | 3000 ml | 15 cm |
| | bottle | | | | | | | | |
| SB 9c | flexible | 3000 ml | n/a | n/a | n/a | n/a | n/a | 3000 ml | 15 cm |
| | bottle | | | | | | | | |

| | | | Outlet | outlet | | Outlet tube | Outlet tube | Nozzle | | |
|---|---|---|---|---|---|---|---|---|---|---|
| | | | tube inner | tube | outlet | height above/ | constriction | inner | | Nozzle |
| Design | Reservoir | Reservoir | diameter | length | tube | below 4 cm | inner | diam. | Reservoir | length |
| Name | diameter | shape | (mm) | (cm) | orientation | DE level (cm) | diameter (mm) | (mm) | height | (cm) |
| SB 1 | 8 cm | flexible | 6.6 mm | 15 cm | vertical | negative | n/a | 4.1 mm | 15 cm | 12 cm |
| | | upright | | | | 4 cm | | | | |
| | | bottle | | | | | | | | |
| SB 2 | 8 cm | flexible | 6.6 mm | 15 cm | vertical | negative | n/a | 4.1 mm | 15 cm | 12 cm |
| | | upright | | | | 4 cm | | | | |
| | | bottle | | | | | | | | |
| SB 3 | 8 cm | flexible | 6.6 mm | 15 cm × 4 | vertical × 4 | negative | n/a | 4.1 mm | 15 cm | 12 cm |
| | | upright | | | | 4 cm × 4 | | | | |
| | | bottle | | | | | | | | |
| SB 4 | 8 cm | flexible | 5.6 mm | 15 cm | vertical | negative | n/a | 4.1 mm | 15 cm | 12 cm |
| | | upright | (flex, w | | | 4 cm | | | | |
| | | bottle | weight) | | | | | | | |
| SB 5 | 8 cm | flexible | 3.6 mm | 15 cm | vertical | negative | n/a | 4.1 mm | 15 cm | 12 cm |
| | | upright | | | | 4 cm | | | | |
| | | bottle | | | | | | | | |
| SB 6 | 8 cm | flexible | 6 mm | 15 cm | vertical | negative | 3 mm & | 4.1 mm | 15 cm | 12 cm |
| | | upright | | | | 4 cm | 3.4 mm | | | |
| | | bottle | | | | | | | | |
| SB 7 | 8 cm | flexible | 5.6 mm | 15 cm | vertical | negative | 3 mm & | 4.1 mm | 15 cm | 12 cm |
| | | upright | | | | 4 cm | 3.8 mm | | | |
| | | bottle | | | | | | | | |
| SB 8 | 8 cm | flexible | 6 mm | 15 cm | vertical | negative | 3 mm & | 4.1 mm | 15 cm | 12 cm |
| | | upright | | | | 4 cm | 3.8 mm | | | |
| | | bottle | | | | | | | | |
| SB 9a | 8 cm | flexible | 6 mm | 15 cm | vertical | negative | n/a | 4.1 mm | 15 cm | 20 cm |
| | | upright | | | | 4 cm | | | | |
| | | bottle | | | | | | | | |
| SB 9b | 8 cm | flexible | 6 mm | 15 cm | vertical | negative | n/a | 3 mm | 15 cm | 20 cm |
| | | upright | | | | 4 cm | | | | |
| | | bottle | | | | | | | | |
| SB 9c | 8 cm | flexible | 11 mm | 15 cm | vertical | negative | n/a | 4.1 mm | 15 cm | 13 cm |
| | | upright | | | | 4 cm | | | | |
| | | bottle | | | | | | | | |

| | | Airflow path: | AVG ml. of | | | | | |
|---|---|---|---|---|---|---|---|---|
| | | squeeze bottle, | DE exiting | | | | | |
| | Nozzle | bulb pressure | nozzle (4 | | | | | |
| | constriction | tube, reservoir, | lbs of | std. dev | Any | Can apply | Can apply | Can apply |
| Design | inner | DE, outlet | force for | of volume | component | DE at −45 | DE at 0 | DE at +45 |
| Name | diameter | tube, nozzle | 1 sec.) | dispensed | clogging? | degree tilt? | degree tilt? | degree tilt? |
| SB 1 | 2.4 mm | sb, DE, ot, nzl | 0.14 ml | >40% | outlet tube | yes | yes | yes |
| | | | GOOD | | and nozzle | | | |
| SB 2 | 2.4 mm | sb, relief holes, | 0 ml | n/a | n/a | no | no | no |
| | | nzl | | | | | | |
| SB 3 | 2.4 mm | sb, DE, ot, nzl | 0.11 ml | <5% | no | yes | yes | yes |
| | | | GOOD | | | | | |
| SB 4 | n/a | sb, DE, ot, nzl | 0.21 ml | >40% | no | yes | yes | yes |
| | | | GOOD | | | | | |
| SB 5 | 2.4 mm | sb, DE, ot, nzl | 0.03 ml | <5% | outlet tube | yes | yes | yes |
| | | | | | constriction | | | |
| SB 6 | 2.4 mm | sb, DE, ot, nzl | 0.25 ml | <5% | outlet tube | yes | yes | yes |
| | | | GOOD | | constriction | | | |
| SB 7 | 2.4 mm | sb, DE, ot, nzl | 0.17 ml | <5% | outlet tube | yes | yes | yes |
| | | | GOOD | | constriction | | | |
| SB 8 | 2.4 mm | sb, DE, ot, nzl | 1.0 ml | <5% | no | yes | yes | yes |
| | | | GOOD | | | | | |
| SB 9a | n/a | sb, DE, ot, nzl | 0.19 ml | <5% | no | yes | yes | yes |
| | | | GOOD | | | | | |
| SB 9b | n/a | sb, DE, ot, nzl | 0.03 ml | <5% | nozzle | yes | yes | yes |
| SB 9c | n/a | sb, DE, ot, nzl | 3.2 ml | <5% | no | yes | yes | yes |

TABLE 2

| | | Volume of | Pressure | | | Pressure tube | Pressure tube | | |
|---|---|---|---|---|---|---|---|---|---|
| | Pressure | pressure | tube | Pressure | Pressure | height above/ | constriction | Reservoir | |
| Design | Generating | generating | inner | tube | tube | below 4 cm | inner | volume | Reservoir |
| Name | Component | component | diameter | length | orientation | DE level (cm) | diameter (mm) | (ml) | height |
| BLB 1a | bulb | 90 ml | 6 mm | 11 cm | vertical | pos. 4 cm | n/a | 3000 ml | 15 cm |
| BLB 1b | bulb | 90 ml | 6 mm | 11 cm | vertical | pos. 4 cm | n/a | 3000 ml | 15 cm |
| BLB 2 | bulb | 90 ml | 6 mm | 15 cm | vertical | neg. 4 cm | n/a | 6786 ml | 15 cm |
| BLB 3 | bulb | 90 ml | 6 mm | 15 cm | vertical | neg. 4 cm | n/a | 6786 ml | 15 cm |
| BLB 3b | bulb | 130 ml | 6 mm | 15 cm | vertical | neg. 4 cm | n/a | 6786 ml | 15 cm |
| BLB 4 | bulb | 90 ml | 6 mm | 15 cm | vertical | neg. 4 cm | n/a | 6786 ml | 15 cm |
| BLB 5 | bulb | 90 ml | 6 mm | 7 cm | vertical | pos. 4 cm | n/a | 6786 ml | 15 cm |
| BLB 6 | bulb | 90 ml | 6 mm | 15 cm | vertical | neg. 4 cm | n/a | 3000 ml | 15 cm |
| BLB 7 | bulb | 90 ml | 6 mm | 15 cm | vertical | neg. 4 cm | n/a | 3000 ml | 15 cm |

| | | | Outlet | outlet | | Outlet tube | Outlet tube | Nozzle | |
|---|---|---|---|---|---|---|---|---|---|
| | | | tube inner | tube | outlet | height above/ | constriction | inner | |
| Design | Reservoir | Reservoir | diameter | length | tube | below 4 cm | inner | diam. | Nozzle |
| Name | diameter | shape | (mm) | (cm) | orientation | DE level (cm) | diameter (mm) | (mm) | length |
| BLB 1a | 8 cm | inflexible | 6.6 mm | 11 cm | vertical | pos. 4 cm | n/a | 4.1 mm | 12 cm |
| | | upright | | | | | | | |
| | | bottle | | | | | | | |
| BLB 1b | 8 cm | inflexible | 6.6 mm | 11 cm | vertical | neg. 4 cm | n/a | 4.1 mm | 12 cm |
| | | upright | | | | | | | |
| | | bottle | | | | | | | |
| BLB 2 | 12 cm | inflexible | 6.6 mm | 15 cm | vertical | neg. 4 cm | n/a | 6.6 mm | 12 cm |
| | | upright | | | | | | | |
| | | bottle | | | | | | | |
| BLB 3 | 12 cm | inflexible | 6.6 mm | 7 cm | vertical | pos. 4 cm | n/a | 6.6 mm | 12 cm |
| | | upright | | | | | | | |
| | | bottle | | | | | | | |
| BLB 3b | 12 cm | inflexible | 6.6 mm | 7 cm | vertical | pos. 4 cm | n/a | 6.6 mm | 12 cm |
| | | upright | | | | | | | |
| | | bottle | | | | | | | |
| BLB 4 | 12 cm | inflexible | 6.6 mm | 3 cm | vertical | pos. 8 cm | n/a | 6.6 mm | 12 cm |
| | | upright | | | | | | | |
| | | bottle | | | | | | | |
| BLB 5 | 12 cm | inflexible | 6.6 mm | 7 cm | vertical | pos. 4 cm | n/a | 6.6 mm | 12 cm |
| | | upright | | | | | | | |
| | | bottle | | | | | | | |
| BLB 6 | 8 cm | inflexible | 6.6 mm | 15 cm | vertical | neg. 4 cm | n/a | 6.6 mm | 12 cm |
| | | upright | | | | | | | |
| | | bottle | | | | | | | |
| BLB 7 | 8 cm | inflexible | 6.6 mm | 7 cm | vertical | pos. 4 cm | n/a | 6.6 mm | 12 cm |
| | | upright | | | | | | | |
| | | bottle | | | | | | | |

| | | Airflow path: | AVG ml. of | | | | | |
|---|---|---|---|---|---|---|---|---|
| | | squeeze bottle, | DE exiting | | | | | |
| | Nozzle | bulb pressure | nozzle (4 | | | | | |
| | constriction | tube, reservoir, | lbs of | std. dev of | Any | Can apply | Can apply | Can apply |
| Design | inner | DE, outlet | force for | volume | component | DE at −45 | DE at 0 | DE at +45 |
| Name | diameter | tube, nozzle | 1 sec.) | dispensed | clogging? | degree tilt? | degree tilt? | degree tilt? |
| BLB 1a | 2.4 mm | blb, pt, res, ot, | o ml | n/a | n/a | no | no | no |
| | | nzl | | | | | | |
| BLB 1b | 2.4 mm | blb, pt, res, DE, | 3.7 ml | >40% | nozzle | yes | yes | yes |
| | | ot × 2, nzl | | | | | | |
| BLB 2 | n/a | blb, pt, DE, res, | 4.0 ml | >40% | no | no | yes | no |
| | | DE, ot, nzl | | | | | | |
| BLB 3 | n/a | blb, pt, DE, res, | 0.08 ml | <5% | no | no | yes | no |
| | | ot, nzl | (close, a | | | | | |
| | | | bit light) | | | | | |
| BLB 3b | n/a | blb, pt, DE, res, | 0.15 | <5% | no | yes | yes | no |
| | | ot, nzl | GOOD | | | | | |
| BLB 4 | n/a | blb, pt, DE, res, | 0.01 ml | <5% | no | no | yes | no |
| | | ot, nzl | | | | | | |
| BLB 5 | n/a | blb, pt, res, DE, | 0.02 ml | <5% | no | no | yes | no |
| | | ot, nzl | | | | | | |
| BLB 6 | n/a | blb, pt, res, DE, | 0.03 ml | >40% | no | no | yes | no |
| | | ot, nzl | (too low) | | | | | |
| BLB 7 | n/a | blb, pt, res, DE, | 0.21 | <5% | no | yes | yes | no |
| | | ot, nzl | GOOD | | | | | |

TABLE 3

| | | Volume of | Pressure | | | Pressure tube | Pressure tube | | |
|---|---|---|---|---|---|---|---|---|---|
| | Pressure | pressure | tube | Pressure | Pressure | height above/ | constriction | Reservoir | |
| Design | generating | generating | inner | tube | tube | below 4 cm | inner | volume | Reservoir |
| Name | component | component | diameter | length | orientation | DE level (cm) | diameter (mm) | (ml) | height |
| LOW | bulb | 90 ml | 6 mm | 0 cm | base, | neg. 4 cm | n/a | 6786 ml | 15 cm |
| BLB 1 | | | | | horizontal | | | | |
| LOW | bulb | 90 ml | 6 mm | 0 cm | base, | neg. 4 cm | n/a | 6786 ml | 15 cm |
| BLB 2 | | | | | horizontal | | | | |
| LOW | bulb | 90 ml | 6 mm | 0 cm | base, | neg. 4 cm | n/a | 6786 ml | 15 cm |
| BLB 3 | | | | | horizontal | | | | |
| EFLASK | bulb | 90 ml | 6 mm | 15 cm | vertical | neg. 4 cm | n/a | 4000 ml | 15 cm |
| 1 | | | | | | | | | |
| EFLASK | bulb | 90 ml | 6 mm | 7 cm | vertical | pos. 4 cm | n/a | 4000 ml | 15 cm |
| 2 | | | | | | | | | |
| FFLASK | bulb | 90 ml | 6 mm | 7 cm | vertical | pos. 4 cm | n/a | 1000 ml | 15 cm |
| 1 | | | | | | | | | |
| FFLASK | bulb | 90 ml | 6 mm | 15 cm | vertical | neg. 4 cm | n/a | 1000 ml | 15 cm |
| 2 | | | | | | | | | |
| FFLASK | bulb | 90 ml | 6 mm | 15 cm | vertical | neg. 4 cm | n/a | 1000 ml | 15 cm |
| 3 | | | | | | | | | |

| | | | Outlet | | | | | | |
|---|---|---|---|---|---|---|---|---|---|
| | | | tube | outlet | | Outlet tube | Outlet tube | Nozzle | |
| | | | inner | tube | outlet | height above/ | constriction | inner | |
| Design | Reservoir | Reservoir | diameter | length | tube | below 4 cm | inner | diam. | Nozzle |
| Name | diameter | shape | (mm) | (cm) | orientation | DE level (cm) | diameter (mm) | (mm) | length |
| LOW | 12 cm | inflexible | 6.6 mm | 3 cm | vertical | pos. 8 cm | n/a | 6.6 mm | 12 cm |
| BLB 1 | | upright | | | | | | | |
| | | bottle | | | | | | | |
| LOW | 12 cm | inflexible | 6.6 mm | 15 cm | vertical | neg. 4 cm | n/a | 6.6 mm | 12 cm |
| BLB 2 | | upright | | | | | | | |
| | | bottle | | | | | | | |
| LOW | 12 cm | inflexible | 6.6 mm | 7 cm | vertical | pos. 4 cm | n/a | 6.6 mm | 12 cm |
| BLB 3 | | upright | | | | | | | |
| | | bottle | | | | | | | |
| EFLASK | conical | inflexible | 6.6 mm | n/a | n/a | pos. 15 cm | n/a | 5 mm | 12 cm |
| 1 | | upright | | | | | | | |
| | | bottle | | | | | | | |
| EFLASK | conical | inflexible | 6.6 mm | n/a | n/a | pos. 15 cm | n/a | 5 mm | 12 cm |
| 2 | | upright | | | | | | | |
| | | bottle | | | | | | | |
| FFLASK | 6.2 cm | inflexible | 6.6 mm | 3 cm | vertical | pos. 8 cm | n/a | 6.6 mm | 12 cm |
| 1 | | upright | | | | | | | |
| | | spherical | | | | | | | |
| | | container | | | | | | | |
| FFLASK | 6.2 cm | inflexible | 6.6 mm | 3 cm | vertical | pos. 8 cm | n/a | 6.6 mm | 12 cm |
| 2 | | upright | | | | | | | |
| | | spherical | | | | | | | |
| | | container | | | | | | | |
| FFLASK | 6.2 cm | inflexible | 6.6 mm | 7 cm | vertical | pos. 4 cm | n/a | 6.6 mm | 12 cm |
| 3 | | upright | | | | | | | |
| | | spherical | | | | | | | |
| | | container | | | | | | | |

| | | Airflow path: | AVG ml. of | | | | | |
|---|---|---|---|---|---|---|---|---|
| | | squeeze bottle, | DE exiting | | | | | |
| | Nozzle | bulb pressure | nozzle (4 | | | | | |
| | constriction | tube, reservoir, | lbs of | std. dev | Any | Can apply | Can apply | Can apply |
| Design | inner | DE, outlet | force for | of volume | component | DE at −45 | DE at 0 | DE at +45 |
| Name | diameter | tube, nozzle | 1 sec.) | dispensed | clogging? | degree tilt? | degree tilt? | degree tilt? |
| LOW | n/a | blb, DE, res, ot, | o ml | n/a | n/a | no | no | no |
| BLB 1 | | nzl | | | | | | |
| LOW | n/a | blb, DE, res, | 0 ml | n/a | n/a | no | no | no |
| BLB 2 | | DE, ot, nzl | | | | | | |
| LOW | n/a | blb, DE, res, ot, | 0.19 ml | <5% | no | yes | yes | no |
| BLB 3 | | nzl | GOOD | | | | | |
| EFLASK | 2.4 mm | blb, DE, res, ot, | 0.07 ml | <5% | no | no | yes | yes |
| 1 | | nzl | (close, a | | | | | |
| | | | bit low) | | | | | |
| EFLASK | 2.4 mm | blb, ot, res, DE, | 0.04 ml | <5% | no | yes | yes | yes |
| 2 | | res, nzl | | | | | | |
| FFLASK | n/a | blb, pt, res, DE, | 0.01 ml | <5% | no | yes | yes | yes |
| 1 | | res, ot, nzl | | | | | | |
| FFLASK | n/a | blb, pt, DE, res, | 004 ml | <5% | no | yes | yes | yes |
| 2 | | ot, nzl | | | | | | |
| FFLASK | n/a | blb, pt, DE, | 0.24 ml | <5% | no | yes | yes | yes |
| 3 | | res, ot, nzl | GOOD | | | | | |

TABLE 4

| | | Volume of | Pressure | | | Pressure tube | Pressure tube | | |
|---|---|---|---|---|---|---|---|---|---|
| | Pressure | pressure | tube | Pressure | Pressure | height above/ | constriction | Reservoir | |
| Design | Generating | generating | inner | tube | tube | below 4 cm | inner | volume | Reservoir |
| Name | Component | component | diameter | length | orientation | DE level (cm) | diameter (mm) | (ml) | height |
| HHELD | bulb | 130 ml | 8 mm | 7 cm | center base, | neg. 4 cm | n/a | 1000 ml | 15 cm |
| 1 | | | | | horizontal | | | | |
| HHELD | bulb | 130 ml | 8 mm | 7 cm | center base, | neg. 4 cm | n/a | 1000 ml | 15 cm |
| 2 | | | | | horizontal | | | | |
| HHELD | bulb | 130 ml | 8 mm | 3 cm | horizontal | pos 2 cm | n/a | 1000 ml | 15 cm |
| 3 | | | | | | | | | |
| HHELD | bulb | 130 ml | 8 mm | 7 cm | center base, | neg. 4 cm | 3.2 mm | 1000 ml | 15 cm |
| 4 | | | | | horizontal | | | | |
| HHELD | bulb | 130 ml | 6 mm | 27 cm | center base, | neg. 4 cm | n/a | 1000 ml | 15 cm |
| 5 | | | | | horizontal | | | | |
| HHELD | bulb | 130 ml | 6 mm | 7 cm | center base, | neg. 4 cm | n/a | 1000 ml | 15 cm |
| 6 | | | | | horizontal | | | | |
| HHELD | bulb | 130 ml | 6 mm | 7 cm (×3) | center base, | neg. 4 cm | n/a | 1000 ml | 15 cm |
| 7 | | | | | horizontal | | | | |
| HHELD | bulb | 130 ml | 6 mm | 6 cm | center base, | neg. 4 cm | 2 mm | 1000 ml | 15 cm |
| 8 | | | | | horizontal | | | | |
| HHELD | bulb | 130 ml | 10 mm | 7 cm | center base, | neg. 4 cm | n/a | 1000 ml | 15 cm |
| 9 | | | | | horizontal | | | | |
| HHELD | bulb | 130 ml | 6 mm | 7 cm | center base, | neg. 4 cm | n/a | 1000 ml | 16 cm |
| 10 | | | | | horizontal | | | | |

| | | | Outlet | | | | | | |
|---|---|---|---|---|---|---|---|---|---|
| | | | tube | outlet | | Outlet tube | Outlet tube | Nozzle | |
| | | | inner | tube | outlet | height above/ | constriction | inner | |
| Design | Reservoir | Reservoir | diameter | length | tube | below 4 cm | inner | diam. | Nozzle |
| Name | diameter | shape | (mm) | (cm) | orientation | DE level (cm) | diameter (mm) | (mm) | length |
| HHELD | 6.2 cm | inflexible | 3.5 mm | 3 cm | top | pos. 7 cm | n/a | 2.5 mm | 6 cm |
| 1 | | sideways | | | horizontal | | | | |
| | | spherical | | | | | | | |
| | | container | | | | | | | |
| HHELD | 6.2 cm | inflexible | 3.5 mm | 3 cm | top | pos. 7 cm | n/a | 3.5 mm | 6 cm |
| 2 | | sideways | | | horizontal | | | | |
| | | spherical | | | | | | | |
| | | container | | | | | | | |
| HHELD | 6.2 cm | inflexible | 3.5 mm | 3 cm | top | pos. 7 cm | n/a | 3.5 mm | 6 cm |
| 3 | | sideways | | | horizontal | | | | |
| | | spherical | | | | | | | |
| | | container | | | | | | | |
| HHELD | 6.2 cm | inflexible | 3.5 mm | 3 cm | top | pos. 7 cm | n/a | 3.5 mm | 6 cm |
| 4 | | sideways | | | horizontal | | | | |
| | | spherical | | | | | | | |
| | | container | | | | | | | |
| HHELD | 6.2 cm | inflexible | 4 mm | 3 cm | top-front | pos. 7 cm | n/a | 4 mm | 24 cm |
| 5 | | sideways | | | horizontal | | | | |
| | | spherical | | | | | | | |
| | | container | | | | | | | |
| HHELD | 6.2 cm | inflexible | 4 mm | 10 cm | top-rear | pos. 7 cm | n/a | 4 mm | 6 cm |
| 6 | | sideways | | | horizontal | | | | |
| | | spherical | | | | | | | |
| | | container | | | | | | | |
| HHELD | 6.2 cm | inflexible | 4 mm | 10 cm | top-rear | pos. 7 cm | n/a | 4 mm | 6 cm |
| 7 | | sideways | | | horizontal | | | | |
| | | spherical | | | | | | | |
| | | container | | | | | | | |
| HHELD | 6.2 cm | inflexible | 4 mm | 10 cm | top-rear | pos. 7 cm | n/a | 4 mm | 6 cm |
| 8 | | sideways | | | horizontal | | | | |
| | | spherical | | | | | | | |
| | | container | | | | | | | |
| HHELD | 6.2 cm | inflexible | 4 mm | 10 cm | top-rear | pos. 7 cm | n/a | 4 mm | 6 cm |
| 9 | | sideways | | | horizontal | | | | |
| | | spherical | | | | | | | |
| | | container | | | | | | | |
| HHELD | 6.2 cm | inflexible | 4 mm | 10 cm | center, | neg. 4 cm | n/a | 4 mm | 6 cm |
| 10 | | sideways | | | base, | | | | |
| | | spherical | | | horizontal | | | | |
| | | container | | | | | | | |

| | | Airflow path: | AVG ml. of | | | | | |
|---|---|---|---|---|---|---|---|---|
| | | squeeze bottle, | DE exiting | | | | | |
| | Nozzle | bulb pressure | nozzle (4 | | | | | |
| | constriction | tube, reservoir, | lbs of | std. dev | Any | Can apply | Can apply | Can apply |
| Design | inner | DE, outlet | force for | of volume | component | DE at −45 | DE at 0 | DE at +45 |
| Name | diameter | tube, nozzle | 1 sec.) | dispensed | clogging? | degree tilt? | degree tilt? | degree tilt? |
| HHELD | n/a | blb, pt, DE, res, | 0.06 ml | <5% | no | yes | yes | yes |
| 1 | | ot, nzl | (a bit | | | | | |
| | | | too low, | | | | | |
| | | | bulb hard | | | | | |
| | | | to reinflate) | | | | | |
| HHELD | n/a | blb, pt, DE, res, | 0.28 ml | <5% | no | yes | yes | yes |
| 2 | | ot, nzl | GOOD | | | | | |
| HHELD | n/a | blb, pt, res DE, | 0.01 ml | <5% | no | yes | yes | yes |
| 3 | | res, ot, nzl | | | | | | |
| HHELD | n/a | blb, pt, res DE, | 0.4 ml | <5% | no | yes | yes | yes |
| 4 | | res, ot, nzl | (perfect | | | | | |
| | | | with good | | | | | |
| | | | control) | | | | | |
| HHELD | n/a | blb, pt, DE, res, | 0.01 ml | <5% | nozzle | no | yes | yes |
| 5 | | ot, nzl | | | | | | |
| HHELD | n/a | blb, pt, DE, res, | 0.34 ml | <5% | no | yes | yes | yes |
| 6 | | ot, nzl | GOOD | | | | | |
| HHELD | n/a | blb, pt, DE, res, | 0.23 ml | <5% | no | yes | yes | yes |
| 7 | | ot, nzl | GOOD | | | | | |
| HHELD | n/a | blb, pt, DE, res, | 0.06 ml | <5% | no | yes | yes | yes |
| 8 | | ot, nzl | (slightly | | | | | |
| | | | too low) | | | | | |
| HHELD | n/a | blb, pt, DE, res, | 0.28 ml | <5% | no | yes | yes | yes |
| 9 | | ot, nzl | GOOD | | | | | |
| HHELD | n/a | blb, pt, DE, res, | 2.4 ml | >40% | no | yes | yes | yes |
| 10 | | DEot, nzl | | | | | | |

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are consistent with the broadest interpretation of the specification as a whole.

1. A silica agent applicator, comprising:
a reservoir for containing a silica agent;
a hollow, deformable bulb adapted to be squeezed to force air through a first air tube fluidly connecting the bulb and a bottom of the reservoir; and
a second tube extending from a top of the reservoir to an exit of the applicator, to convey aerosolized silica agent out of the applicator for application onto a surface or an insect.

2. The applicator of claim 1, wherein the first air tube has an inner diameter within a range of 6 mm to 10 mm.

3. The applicator of claim 1, wherein the first air tube further comprises a constriction with an inner diameter of 3.2 mm.

4. The applicator of claim 1, wherein the second tube has an inner diameter within a range of 3.5 mm to 6 mm.

5. The applicator of claim 4, wherein the applicator dispenses within a range of 0.1 to 1.0 ml of silica agent per squeeze of the bulb.

6. The applicator of claim 4, wherein the applicator dispenses within a range of 0.1 to 1.0 ml of silica agent per squeeze of the bulb, and
wherein the squeeze of the bulb is defined as 4 lbs. of hand pressure applied for 1 second.

7. The applicator of claim 1, wherein the reservoir further comprises a removable cap to allow refilling of the silica agent.

8. The applicator of claim 7, wherein the removable cap is threaded.

9. The applicator of claim 1, wherein the second tube further comprises a flexible nozzle fluidly connected to dispense from the applicator, and is made of a flexible material such that the nozzle can dispense the silica agent into narrow crevices, holes, and wall voids.

10. The applicator of claim 9, wherein the nozzle has an internal diameter within a range of 3.5 mm to 6.6 mm.

11. The applicator of claim 1, wherein the applicator further comprises supports to allow the applicator to stand vertically during storage.

12. The applicator of claim 1, wherein the silica agent is diatomaceous earth.

13. A silica agent applicator, comprising:
a reservoir for containing diatomaceous earth;
a hollow, deformable bulb adapted to be squeezed to force air through a first air tube fluidly connecting the bulb and a bottom of the reservoir; and
a second tube extending from a top of the reservoir to an exit of the applicator, to convey aerosolized diatomaceous earth out of the applicator for application onto a surface or an insect.
